(19) United States
(12) Patent Application Publication
(10) Pub. No.: US 2013/0300151 A1
(43) Pub. Date: Nov. 14, 2013

(54) Air Foil for Vehicles

(71) Applicants: Robert F. Lauer, Frederick, MD (US); Lupe Lauer, Frederick, MD (US)

(72) Inventors: Robert F. Lauer, Frederick, MD (US); Lupe Lauer, Frederick, MD (US)

(21) Appl. No.: 13/855,690

(22) Filed: Apr. 2, 2013

Related U.S. Application Data
(60) Provisional application No. 61/686,213, filed on Apr. 2, 2012.

(51) Int. Cl. B62D 35/00

(52) U.S. Cl. CPC B62D 35/00
USPC 296/180.1

(57) ABSTRACT

The invention provides an Air Foil for Vehicles, is a specially designed cover for the backs of pickup trucks and trailers that provides them an aerodynamic quality and provides lift reducing their effective weight as they travel in a forward direction. The invention is a self contained system that reduces energy needed to power a motor vehicle without requiring an excess use of fossil fuels. The Air Foil for Vehicles applies an auto wing mobile airfoil configuration to the bed of a pickup truck and the open area of a trailer to lift the back ends off the road and facilitate a smoother ride and better miles per gallon.

### CLAIM OF PRIORITY

This patent application claims priority under 35 USC 119 (e) (1) from U.S. Provisional Patent Application Ser. No. 61/686,213 filed Apr. 2, 2012, of common inventorship herewith entitled, “Air foil For Vehicles.

### FIELD OF THE INVENTION

The present invention pertains to the field of vehicle engineering, and more specifically to the field of aerodynamic vehicle engineering.

### BACKGROUND OF THE INVENTION

The prior art has put forth several designs for aerodynamic vehicle engineering. Among these are:

U.S. Pat. No. 5,908,217 to Robert J. Englar describes a pneumatic aerodynamic control and drag reduction system for ground vehicles. A blowing system for controlling the aerodynamics of a ground vehicle comprises a source of compressed air, a valve for regulating the flow of the compressed air and a plenum for discharging the air at a rear portion of the vehicle. The air discharged through the plenum prevents flow separation and consequently reduces the drag on the vehicle. This system increases lift, reducing effective weight and rolling resistance of the tires, or decreases lift to improve tire traction and handling. The blowing system has separate plenums for the left and right sides of the vehicle whereby vortex roll up and flow separation which occur on only one side of the vehicle are eliminated. Asymmetrical blowing of only one plenum produces rolling and yawing moments to restore the vehicle's lateral directional stability when exposed to a side wind. A lower plenum is designed for reattaching flow, generating a negative lift or download to increase traction, braking, and handling and for generating pitch trim. The blowing system has sensors for detecting and adjusting aerodynamically to various conditions such as the direction and pressure of a relative wind, turbulence at the rear of the vehicle, braking, or angle of steering.

U.S. Pat. No. 7,152,908 to Khosrow Shahbazi describes a system, method and media for reducing aerodynamic drag of vehicles. This system has a minimum of one fan that directs air into a lower pressure region behind a vehicle in motion and reduces pressure drag. Embodiments include one or more ducts from directing air from other parts of the vehicle to the one fan. In one embodiment, the operation of the one fan may be controlled based on sensed conditions, user control, or other means.

U.S. Pat. No. 7,261,353 to Bruce L. Storms describes dividers for reduction of aerodynamic drag of vehicles with open cavities. A drag reduction concept for vehicles with open cavities includes dividing a cavity into smaller adjacent cavities through installation of one or more vertical dividers. The dividers may extend the full depth of the cavity or only partial depth. The top of the dividers typically are flush with the top of the bed or cargo bay of the vehicle. The dividers are made of material strong enough for both wind loads and forces encountered during cargo loading and unloading. For partial depth dividers, a structural angle may be desired to increase strength.

None of these prior art references describe the present invention.

### SUMMARY OF THE INVENTION

It is an object of the present invention to provide an aerodynamically designed air foil for incorporating into automobiles, trailers and camper tops for truck beds.

### BRIEF DESCRIPTION OF THE DRAWINGS

FIG. 1 is diagonal back view showing an airfoil engineered camper top attached to a truck bed.

FIG. 2 is a diagonal top view showing an eighteen wheeler semi truck with airfoil engineering top applied to its back end.

FIG. 3 is an illustrative side view showing a standard sedan automobile with the airfoil of the present invention applied to its back end.

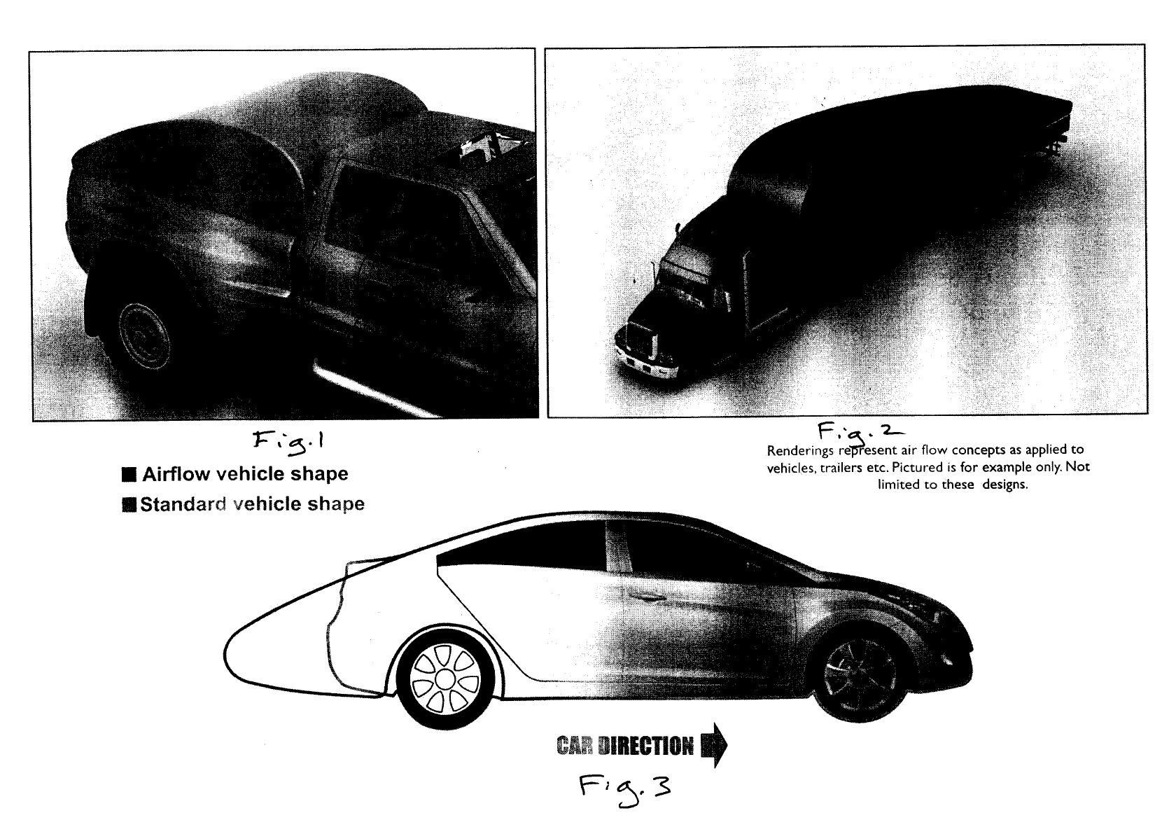

### DETAILED DESCRIPTION OF THE INVENTION

In recent decades, energy shortages and an imposition of stricter environmental standards have created an increased awareness that a genuine need exists to find an alternative power source for the generation of electricity which does not require the use of fossil fuels. This view is reinforced by the fact that more people are realizing the supply of organic based fuels is a finite quantity. Current predictions state that fossil fuel supplies will reach a depletion level during the middle to latter part of the twenty first century.

The present invention, hereinafter referred to as the Air Foil for Vehicles, is a specially designed cover for the backs of pickup trucks and trailers that provides them an aerodynamic quality and provides lift reducing their effective weight as they travel in a forward direction. The present invention also is applicable for manufacturers to incorporate in future designs of back ends of automobile and eighteen wheeler trailers being manufactured in factories. The Air Foil for Vehicles provides an efficient means of reducing the amount of fuel required to power these heavy vehicles. The present invention is a self contained system that reduces energy needed to power a motor vehicle without requiring an excess use of fossil fuels. The Air Foil for Vehicles applies an auto wing mobile airfoil configuration to the bed of a pickup truck and the open area of a trailer to lift the back ends off the road and facilitate a smoother ride and better miles per gallon. The shape of the airfoil of the present invention describes a cardioid upper surface that extends the length of the vehicle from the back of the cab to the back end of the vehicle in the case of a pick-up truck or semi truck. In the case of a sedan, the airfoil extends from the highest point of the roof to elongate and extend the back end. Airfoil design evolves from knowledge of boundary layer properties and the relation between geometry and pressure distribution. The goal of an airfoil design varies. Some airfoils produce low drag without generating any amount of lift. Some airfoils produce low drag while producing a given amount of lift. In some cases, drag is immaterial and maximum lift is important. The lift on an airfoil is the result of its angle of attack and shape, specifically known as its camber. When the angle of attack and shape are positive, the resulting flow field about the airfoil has a higher average velocity on the upper surface than on the lower surface. This velocity difference is necessarily accompanied by a pressure difference which in turn produces the lift force. The lift force also is related directly to the average top and bottom velocity difference, without invoking the pressure.

The Air Foil of the present invention can be comprised of any suitable material such as steel, aluminum, fiberglass, carbon reinforced plastic or other plastic material, for example. The present invention is suitable for attachment to any existing vehicle.

The Air Foil for Vehicles is an innovative invention with advantageous applications in the automotive industry. Particularly for pickup trucks and trailers, implementation of the airfoil design provides these vehicles with an aerodynamic component requiring less energy to move as the speed of the vehicle increases. With less weight on the road, fuel burning is reduced proportionately. In addition to reducing fuel consumption and accompanying fuel costs, the Air Foil for Vehicles concept facilitates a much smoother ride and helps heavily loaded trucks and trailers to avoid the jarring impact of potholes and roadways in other states of disrepair.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An aerodynamically designed air foil device for incorporating into automobiles, trailers and camper tops for truck beds, comprising: a cover for the backs of pickup trucks and trailers that provides them an aerodynamic quality providing lift reducing effective weight as they travel in a forward direction.

2. The aerodynamically designed air foil device of claim 1 for a pickup truck or semi trailer truck comprising the shape of a cardioid upper surface that extends the length of the vehicle from the back of the cab to the back end of the pickup truck or semi trailer truck.

3. The aerodynamically designed air foil device of claim 1 for a sedan comprising the shape of a cardioid upper surface that extends the length of the highest point of the roof to elongate and extend the back end of the sedan.

4. The aerodynamically designed air foil device of claim 2 comprised of steel, aluminum, fiberglass, carbon reinforced plastic or other plastic material.

5. The aerodynamically designed air foil device of claim 3 comprised of steel, aluminum, fiberglass, carbon reinforced plastic or other plastic material.

6. The aerodynamically designed air foil device of claim 2 suitable for attachment to any existing vehicle.

7. The aerodynamically designed air foil device of claim 3 suitable for attachment to any existing vehicle.
